(19) United States
(12) Patent Application Publication
(10) Pub. No.: US 2006/0150543 A1
(43) Pub. Date: Jul. 13, 2006

(54) Assembled frame

(76) Inventor: Welson Won, Shu Lin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/171,431

(22) Filed: Jul. 1, 2005

(30) Foreign Application Priority Data
Dec. 28, 2004 (TW) 93221042

(51) Int. Cl. E06B 1/38

(52) U.S. Cl. 52/201

(57) ABSTRACT

An assembled frame includes U-shaped first and second mating parts separately cut from a plate. The first mating part is complementary to the second mating part, so that they could be joined together to form a square or a rectangular frame. A joining structure is provided at each joint of two opposite ends of the first and the second mating part. The joining structure includes a plurality of dovetailed tenons and corresponding dovetailed mortises respectively formed on the two opposite ends of each joint of the first and the second mating part to join them together. Each of the dovetailed tenons has a forward extended head, which is further riveted to the second mating part after the two mating parts have been joined via the dovetailed tenons and mortises.

### FIELD OF THE INVENTION

The present invention relates to an assembled frame, and more particularly to an assembled frame including two mating parts that are joined together via a joining structure.

### BACKGROUND OF THE INVENTION

Plates and frames are often used in various kinds of products. Conventionally, a square or a rectangular frame is cut from a whole piece of plate. FIG. 1 shows a frame structure 1 that is cut from a whole piece of plate along cutting lines 11. In most cases, the remained portion 12 of the cut plate is scrapped and could not be used to produce another frame structure of the same dimensions. Although the scrapped portion 12 may be recycled, the utilization percentage thereof is low and does not meet the industrial requirements. For a frame manufacturer, the scrapped plate 12 forms a waste of material to increase the manufacturing cost of the frame.

### SUMMARY OF THE INVENTION

A primary object of the present invention is to provide an assembled frame that uses two mating parts to form a complete frame structure to minimize scrapped plate material.

Another object of the present invention is to provide an assembled frame that includes two generally U-shaped mating parts that are firmly joined together via a joining structure.

A further object of the present invention is to provide an assembled frame that includes two generally U-shaped mating parts that are firmly joined at two pairs of opposite ends via joining structure and riveting structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a conventional way of producing a complete frame structure by cutting a whole piece of plate;

FIG. 2 is an exploded plan view of an assembled frame according to a first embodiment of the present invention;

FIG. 3 shows two mating parts of the assembled frame of FIG. 1 is provided at two pairs of opposite ends with a joining structure each;

FIG. 4 is an enlarged view of the circled area A of FIG. 3;

FIG. 5 shows the two mating parts of FIG. 3 are jointed to form the assembled frame of the present invention;

FIG. 6 is a sectional view taken along line 6-6 of FIG. 5;

FIG. 7 is a perspective view of the assembled frame according to the first embodiment of the present invention in a fully assembled state;

FIG. 8 is a perspective view of an assembled frame according to a second embodiment of the present invention;

FIG. 9 is an exploded perspective view of an assembled frame according to a third embodiment of the present invention; and

FIG. 10 is an enlarged view of the circled area B of FIG. 5 showing that the joining structure is optionally provided at each right-angled corner of the mating parts of the assembled frame of the present invention.

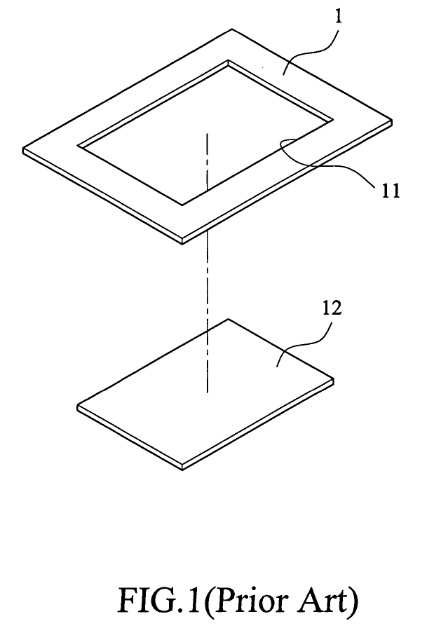

### DETAILED DESCRIPTION OF THE PREFERRED EMBODIMENTS

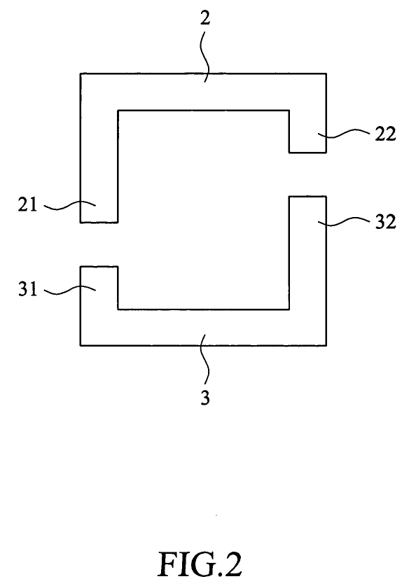

Please refer to FIG. 2 that is an exploded plan view of an assembled frame according to a first embodiment of the present invention. As shown, the assembled frame includes two substantially U-shaped mating parts, namely, a first and a second mating part 2, 3, which are separately cut from a plate and include a first side section 21, 31, and a second side section 22, 32. The first and the second side section 21, 22 of the first mating part 2 respectively have a length that may be determined according to an actual size of the plate from which the first mating part 2 is cut. However, the first and the second side section 31, 32 of the second mating part 3 respectively have a length complementary to that of the first and the second side section 21, 22 of the first mating part 2, respectively, so that the first and the second mating part 2, 3 can be joined to form a square or a rectangular frame.

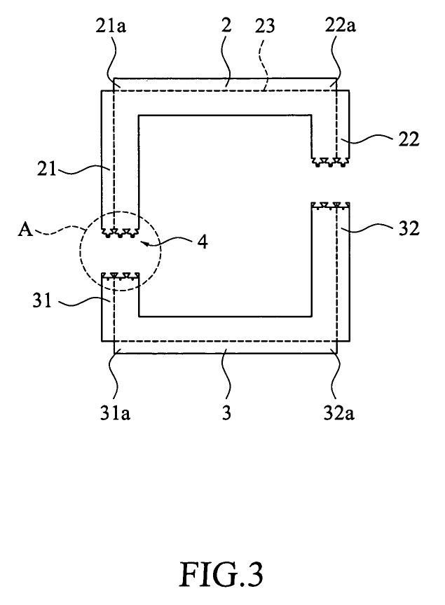

Please refer to FIG. 3. The first and the second mating part 2, 3 of the assembled frame of the present invention are cut at respective two right-angled corners 21a, 22a and 31a, 32a, such that the first and the second mating part 2, 3 may be bent along bending lines 23 in a subsequent bending process to obtain an L-shaped cross section.

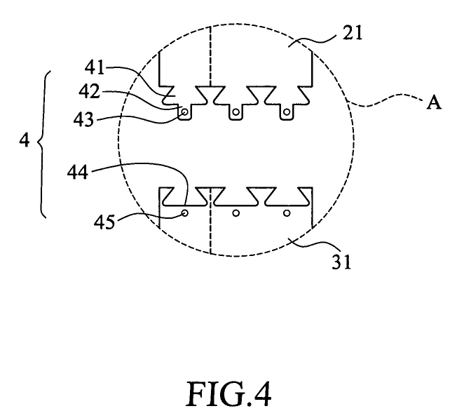

FIG. 4 is an enlarged view of the circled area A of FIG. 3. As shown, a joining structure 4 is provided at two opposite free ends of the first side sections 21, 31 of the first and the second mating part 2, 3, respectively. Similarly, the joining structure 4 is also provided at two opposite free ends of the second side sections 22, 32 of the first and the second mating part 2, 3, respectively. The joining structure 4 includes a plurality of forward projected dovetailed tenons 41 that are formed at the free ends of the first and the second side section 21, 22 of the first mating part 2 and have an extended head 42 each formed at a front end thereof. The joining structure 4 also includes a plurality of dovetailed mortises 44 formed at the free ends of the first and the second side section 31, 32 of the second mating part 3 corresponding to the dovetailed tenons 41.

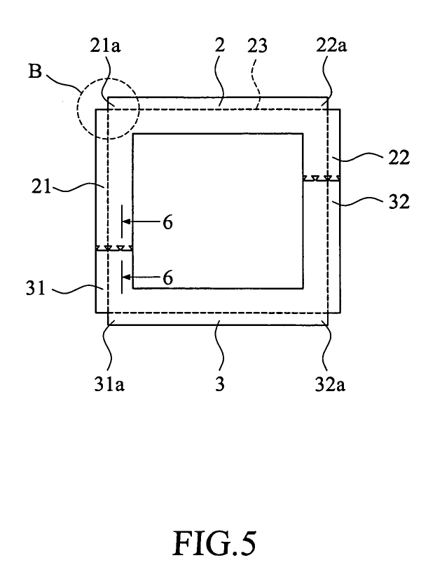

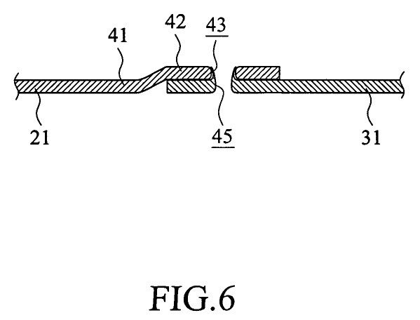

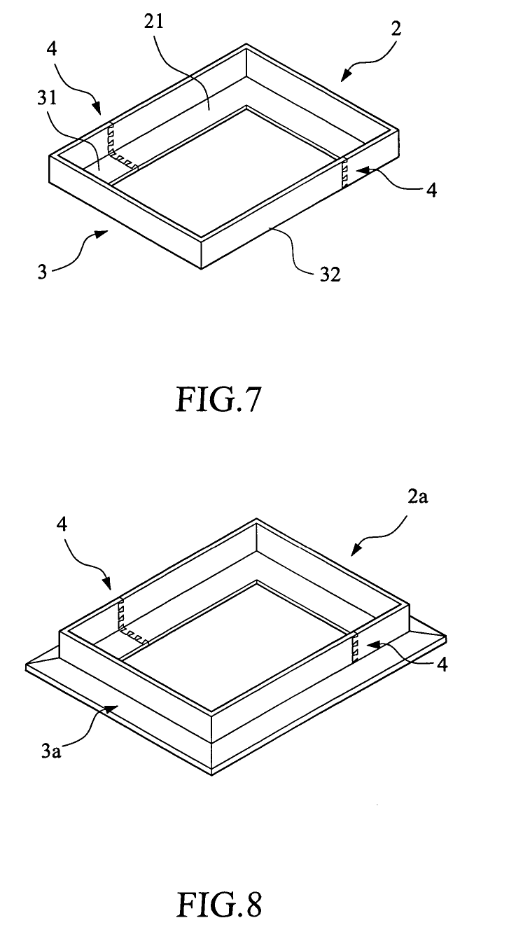

When the first and the second mating part 2, 3 are joined together with the dovetailed tenons 41 engaged with the dovetailed mortises 44, a square or a rectangular frame structure is formed, as shown in FIG. 5. Please refer to FIG. 6 that is a sectional view taken along line 6-6 of FIG. 5. As shown, when the first and the second mating part 2, 3 are joined via the joining structure 4, each of the extended heads 42 overlaps the first or second side section 31, 32 immediately behind the dovetailed mortise 44. A rivet structure is then used to firmly rivet the extended head 42 to the side section 31, 32 via rivet holes 43, 45 separately provided on the extended head 42 and the side section 31, 32. The completed assembled frame according to the first embodiment of the present invention is shown in FIG. 7.

With the above arrangements, the assembled frame formed from the first and the second mating part 2, 3 may be manufactured without producing too much scrapped plate. The joining structure 4 and the riveting structure also enable the first and the second mating part 2, 3 to firmly joined together to form an assembled frame having very high deflection strength, pull resistance, and twisting strength.

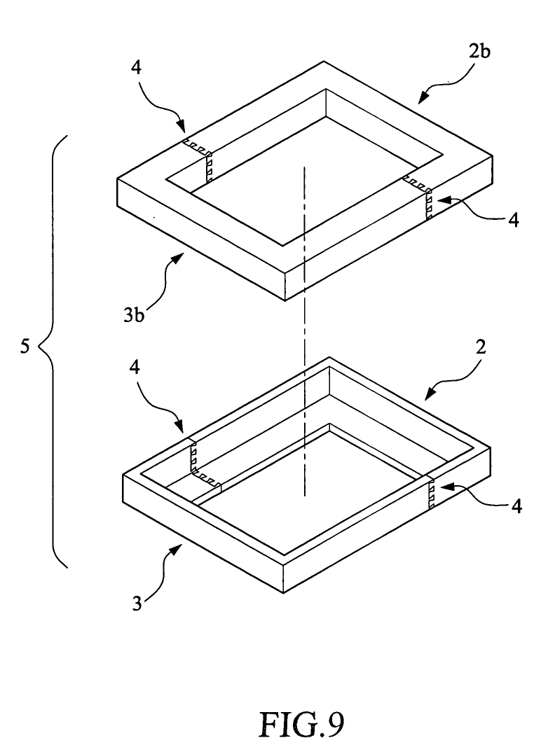

FIG. 8 is a perspective view of an assembled frame according to a second embodiment of the present invention. In the first embodiment shown in FIG. 7, the completed assembled frame includes an inward horizontal flange, so that each side of the assembled frame has a substantially L-shaped cross section. In the second embodiment shown in FIG. 8, the assembled frame is formed from a first and a second mating part 2a, 3a, and includes an outward horizontal flange, so that each side of the assembled frame has a substantially L-shaped cross section.

FIG. 9 is an exploded perspective view of an assembled frame 5 according to a third embodiment of the present invention. The assembled frame 5 includes two vertically stacked and joined assembled frames, namely, a lower assembled frame formed from two mating parts 2, 3 as that shown in FIG. 7, and an upper assembled frame formed from two mating parts 2b, 3b.

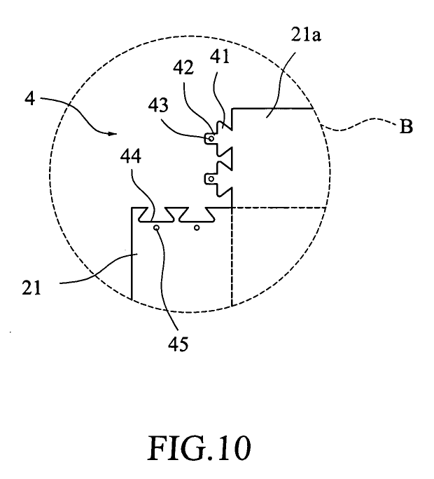

In the present invention, the joining structure may also be provided at each right-angled corner of the first and the second mating part 2, 3 to ensure the stability of the completed assembled frame. FIG. 10 is an enlarged view of the circled area B of FIG. 5 showing the joining structure 4 formed at one right-angled corner of the first mating part 2.

The assembled frame of the present invention effectively overcomes the drawback of wasting too much plate material and therefore largely reduces the material cost thereof and enables an optimized utilization percentage of the plate material. Moreover, as having been mentioned above, with the two mating parts being joined and riveted together via the joining structure and the riveting structure, the assembled frame of the present invention has very high deflection strength, pull resistance, and twisting strength, and is therefore very practical for use to meet the industrial requirements.

What is claimed is:

1. An assembled frame, comprising:
a first mating part being cut from a plate and having a substantially U-shaped configuration to include a first and a second side section;
a second mating part being cut from a plate and having a substantially U-shaped configuration to include a first and a second side section; said first and said second side section of said second mating part respectively having a length complementary to that of said first and said second side section of said first mating part, respectively, such that said first and said second mating part may be joined to form a square or a rectangular frame structure; and
a joining structure being provided at two opposite free ends of said first side sections and of said second side sections of said first and said second mating part for firmly joining said first and said second mating part together to form said assembled frame; and
said joining structure including a plurality of forward projected dovetailed tenons that are formed at the free ends of said first and said second side section of said first mating part, and have an extended head each formed at a front end thereof; and a plurality of dovetailed mortises formed at the free ends of said first and said second side section of said second mating part corresponding to the dovetailed tenons formed on said first mating part.

2. The assembled frame as claimed in claim 1, wherein said extended heads formed at the front ends of said dovetailed tenons of said joining structure overlap said first and said second side section of said second mating part immediately behind said dovetailed mortises when said first and said second mating part are joined via said joining structure.

3. The assembled frame as claimed in claim 1, wherein said extended heads of said dovetailed tenons overlapping said first and said second side section of said second mating part are riveted to said second mating part.

4. The assembled frame as claimed in claim 1, wherein each right-angled corner of said first and said second mating part is provided with said joining structure.

5. The assembled frame as claimed in claim 1, wherein said first and said second mating part are bent to form an inward horizontal flange each, such that said first and said second mating part have a substantially L-shaped cross section.

6. The assembled frame as claimed in claim 5, wherein said first and said second mating part are provided at each right-angled corner thereof with said joining structure to firmly join two opposite ends at said right-angled corner when said first and said second mating part have been bent to form said L-shaped cross section.

7. The assembled frame as claimed in claim 1, wherein said first and said second mating part are bent to form an outward horizontal flange each, such that said first and said second mating part have a substantially L-shaped cross section.

8. The assembled frame as claimed in claim 7, wherein said first and said second mating part are provided at each right-angled corner thereof with said joining structure to firmly join two opposite ends at said right-angled corner when said first and said second mating part have been bent to form said L-shaped cross section.

9. An assembled frame, comprising two vertically stacked and joined assembled frames, namely, an upper and a lower assembled frame;
said upper assembled frame including:
a first mating part being cut from a plate and having a substantially U-shaped configuration to include a first and a second side section, and said first mating part being bent to form an inward horizontal flange, such that said first mating part have a substantially L-shaped cross section;
a second mating part being cut from a plate and having a substantially U-shaped configuration to include a first and a second side section; said second mating part being bent to form an inward horizontal flange, such that said second mating part have a substantially L-shaped cross section corresponding to said first mating part; said first and said second side section of said second mating part respectively having a length complementary to that of said first and said second side section of said first mating part, respectively, such that said first and said second mating part may be joined to form a square or a rectangular frame structure; and
a joining structure being provided at two opposite free ends of said first side sections and of said second side sections of said first and said second mating part for firmly joining said first and said second mating part together to form said upper assembled frame; and
said joining structure including a plurality of forward projected dovetailed tenons that are formed at the free ends of said first and said second side section of said first mating part, and have an extended head each formed at a front end thereof; and a plurality of dovetailed mortises formed at the free ends of said first and said second side section of said second mating part corresponding to the dovetailed tenons formed on said first mating part; and
said lower assembled frame including:
a first mating part being cut from a plate and having a substantially U-shaped configuration to include a first and a second side section, and said first mating part being bent to form an outward horizontal flange, such that said first mating part have a substantially L-shaped cross section;
a second mating part being cut from a plate and having a substantially U-shaped configuration to include a first and a second side section; said second mating part being bent to form an outward horizontal flange, such that said second mating part have a substantially L-shaped cross section corresponding to said first mating part; said first and said second side section of said second mating part respectively having a length complementary to that of said first and said second side section of said first mating part, respectively, such that said first and said second mating part may be joined to form a square or a rectangular frame structure; and
a joining structure being provided at two opposite free ends of said first side sections and of said second side sections of said first and said second mating part for firmly joining said first and said second mating part together to form said upper assembled frame; and
said joining structure including a plurality of forward projected dovetailed tenons that are formed at the free ends of said first and said second side section of said first mating part, and have an extended head each formed at a front end thereof; and a plurality of dovetailed mortises formed at the free ends of said first and said second side section of said second mating part corresponding to the dovetailed tenons formed on said first mating part.

10. The assembled frame as claimed in claim 9, wherein said extended heads formed at the front ends of said dovetailed tenons of said joining structure overlap said first and said second side section of said second mating part immediately behind said dovetailed mortises when said first and said second mating part are joined via said joining structure.

11. The assembled frame as claimed in claim 9, wherein said extended heads of said dovetailed tenons overlapping said first and said second side section of said second mating part are riveted to said second mating part.
